(19) United States
(12) Patent Application Publication
(10) Pub. No.: US 2003/0147601 A1
(43) Pub. Date: Aug. 7, 2003

(54) Hybrid optical module employing integration of electronic circuitry with active optical devices

(76) Inventors: Meir Bartur, Los Angeles, CA (US); Farzad Ghadooshahy, Brentwood, CA (US)

Correspondence Address: David L. Henty, Myers, Dawes & Andras LLP, 19900 MacArthur Blvd., Suite 1150, Irvine, CA, 92612, US

(21) Appl. No.: 10/355,708

(22) Filed: Jan. 31, 2003

Related U.S. Application Data
(60) Provisional application No. 60/353,150, filed on Feb. 1, 2002.

(51) Int. Cl. G02B 6/43

(52) U.S. Cl. 385/92; 385/89

(57) ABSTRACT

A hybrid optical and electrical module is disclosed. The hybrid optical and electrical module includes an optical fiber and an active optical component module configured in a fixed relation to the fiber. The active optical component module includes a substrate, an active optical component mounted on the substrate in a configuration to optically couple to the fiber, and an electrical circuit on the substrate electrically coupled to the active optical component. The electrical circuit includes at least one integrated circuit. The active optical component module includes external electrical leads extending through the substrate to connect with external circuitry.

### RELATED APPLICATION INFORMATION

The present application is related to U.S. Provisional Patent Application serial No. 60/353,150, filed on Feb. 1, 2002, which is incorporated herein by reference and to which priority is claimed pursuant to 35 USC 119 (e).

### BACKGROUND OF THE INVENTION

1. Field of the Invention

This invention relates generally to fiber optical modules for converting an electrical signal to an optical signal for transmission along an optical fiber and for converting a received optical signal to an electrical signal.

2. Description Of The Prior Art And Related Information

Optical modules are used in fiber optic network applications and other applications where optical fibers are coupled to optical components. An optical module may contain one or more active optical components as well as passive optical components, such as beam splitters, filters and lenses, in any of a variety of combinations. The active optical components are used to convert an electrical signal to an optical signal for transmission over the fiber or for converting an optical signal to an electrical signal in receiving an optical signal from the fiber. A laser diode is an example of an active optical component used for transmitting an optical signal. The laser diode emits a modulated light signal based on an input electrical signal, which can be used to transmit information over a fiber. Conversely, a photodiode is an active optical component that will detect optical power received from a fiber and convert it to electrical signals, which are provided to receive circuitry. The electrical transmit and/or receive circuitry in turn is usually configured on a separate printed circuit board (PCB).

The receive circuitry may comprise digital receive circuitry or analog receive circuitry. As noted above such receive circuitry is typically provided on a separate PCB along with digital transmit and receive circuitry. Due to the relatively weak nature of received signals, the optical module/PCB circuitry coupling can negatively affect the signal quality before the signals are amplified and processed by the receive circuitry on the PCB. One disadvantage of significance at higher frequencies is the difficulty to control the high frequency impedance of the connection between the module and the PCB circuitry. This is due to inherent inductance associated with each single lead from the module, packaging capacitance of the optical component package and the variability in lead length between the optical module and the printed circuit board contact. For very high frequency digital signal or broad bandwidth analog signals such as CATV and other multi-channel broad bandwidth RF signals, this may cause significant loss of signal quality.

Therefore a need presently exists for a solution to the problem of poor received signal quality in optical fiber transmission of broad bandwidth signals such as high frequency digital signals and broad bandwidth analog signals such as CATV and other multi-channel broad bandwidth RF signals. Furthermore, a need presently exists for such a solution, which can be implemented efficiently and at relatively low cost.

### SUMMARY

In a first aspect the present invention provides a hybrid optical and electrical module. The hybrid optical and electrical module comprises an optical fiber and a first active optical component module configured in a fixed relation to the fiber. The first active optical component module comprises a substrate, a first active optical component mounted on the substrate to optically couple to the fiber, and an electrical circuit on the substrate electrically coupled to the first active optical component. The electrical circuit comprises at least one integrated circuit and has first external electrical leads to connect with external circuitry. The hybrid optical and electrical module further comprises a second active optical component configured in a fixed relation to the first active optical component module and to the fiber to optically couple to the fiber. The second active optical component has second external electrical leads to connect with external circuitry.

The first active optical component may, for example, comprise a photodiode and the integrated circuit may comprise an amplifier. The first active optical component module may further comprise a lens mounted in the optical path of the first active optical component. The first active optical component module may also comprise a metal housing, wherein the substrate is mounted in the metal housing. The second active optical component may be mounted in a second housing. The first active optical component module, the optical fiber and the second housing may be mounted in a third housing, wherein the third housing has openings to provide electrical contact to the first and second external electrical leads. The hybrid optical and electrical module may also further comprise a rigid base wherein the first active optical component module and the second housing are mounted on the base. The hybrid optical and electrical module may also further comprise an optical fiber holder mounted to the rigid base wherein the optical fiber is mounted in the optical fiber holder. The hybrid optical and electrical module may also further comprise first and second flexible circuit boards coupled to the first and second external electrical leads. The first and second flexible circuit boards may extend out of the third housing to couple the first and second external electrical leads to external circuitry, such as on a printed circuit board. The hybrid optical and electrical module may also further comprise a beam splitter configured in the optical path between the optical fiber, first active optical component and second active optical component. The hybrid optical and electrical module may also further comprise a third active optical component configured in a fixed relation to the fiber to optically couple to the fiber.

In a further aspect the present invention provides a hybrid optical and electrical triplexer module. The hybrid optical and electrical triplexer module comprises a single optical fiber and a laser diode configured in a fixed relation to the fiber, the laser diode having first external electrical leads to connect with external circuitry. The hybrid optical and electrical triplexer module further comprises a first photodiode module configured in a fixed relation to the laser diode and the fiber, the first photodiode module comprising a substrate, a first photodiode mounted on the substrate in a position to optically couple to the fiber to receive light from the fiber, an electrical circuit on the substrate electrically coupled to the first photodiode, and second external electrical leads to connect with external circuitry. The electrical circuit comprises at least one integrated circuit and at least one discrete circuit component. The hybrid optical and electrical triplexer module further comprises a second photodiode module configured in a fixed relation to the laser diode, the first photodiode module and to the fiber. The second photodiode module comprises a second photodiode configured in a position to optically couple to the fiber to receive light from the fiber, and has third external electrical leads to connect with external circuitry.

The hybrid optical and electrical triplexer module further may further comprise a first beam splitter and a second beam splitter configured to direct light from the fiber to the first and second photodiodes, respectively. The integrated circuit may comprise an amplifier and the discrete circuit component(s) may comprise a capacitor and/or a resistor. The first photodiode module may further comprise a housing, wherein the substrate is mounted in the housing.

In another aspect the present invention provides an optical receiver module. The optical receiver module comprises a substrate, a photodiode mounted on the substrate in a position to optically couple to the fiber to receive light from the fiber, and an electrical circuit on the substrate electrically coupled to the first photodiode. The electrical circuit comprises a first amplifier configured as an integrated circuit, a second amplifier configured as an integrated circuit, at least one discrete circuit component, and external electrical leads extending through the substrate to connect with external circuitry on the other side of the substrate.

In a preferred embodiment of the optical receiver module the first and second amplifier are configured symmetrically about the photodiode on the substrate. The discrete circuit components may comprise a plurality of circuit components configured substantially symmetrically about the photodiode. Preferably, the plurality of circuit components are substantially impedance matched. The substrate may further comprise a ground plane layer and a metal via or through hole connecting the ground plane layer to the electrical circuit layer.

Further features and advantages of the present invention will be appreciated by review of the following detailed description.

### BRIEF DESCRIPTION OF THE DRAWINGS

FIGS. 1A and 1B are perspective views of an optical module in accordance with a preferred embodiment of the present invention.

FIGS. 2A-2D are a perspective view, top view, top partial sectional view and a side view, respectively of an assembly of optical components configured in an optical module in accordance with a preferred embodiment of the present invention.

FIGS. 3A-3D are exploded views of a hybrid active optical component module in accordance with a preferred embodiment of the present invention.

FIG. 4 is an electrical schematic drawing of the hybrid active optical component module in accordance with a preferred embodiment of the present invention.

FIG. 5A is a top view of a circuit board layout and FIG. 5B is a side view of the circuit board of a hybrid active optical component module in accordance with a preferred embodiment of the present invention.

### DETAILED DESCRIPTION OF THE INVENTION

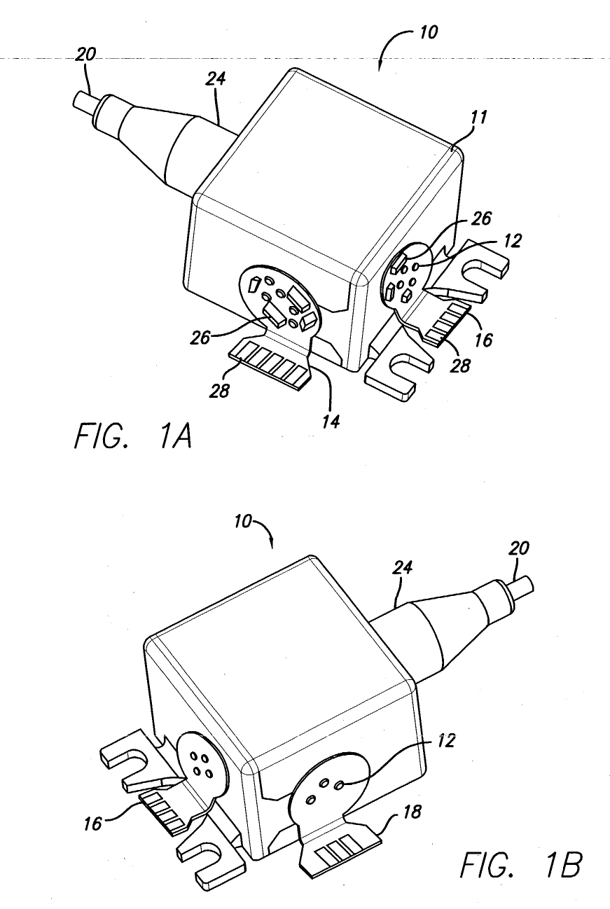

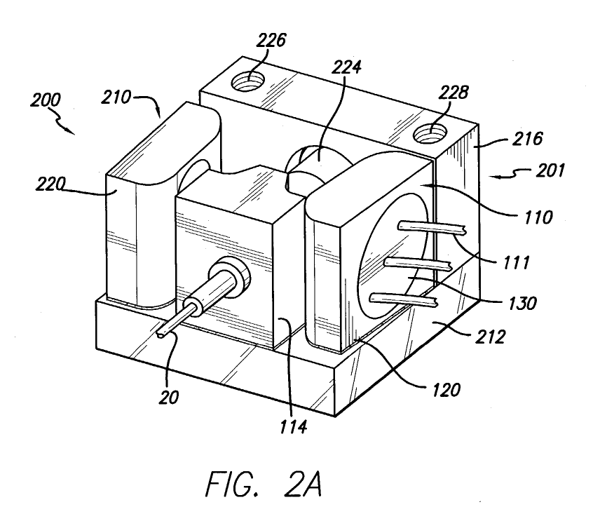

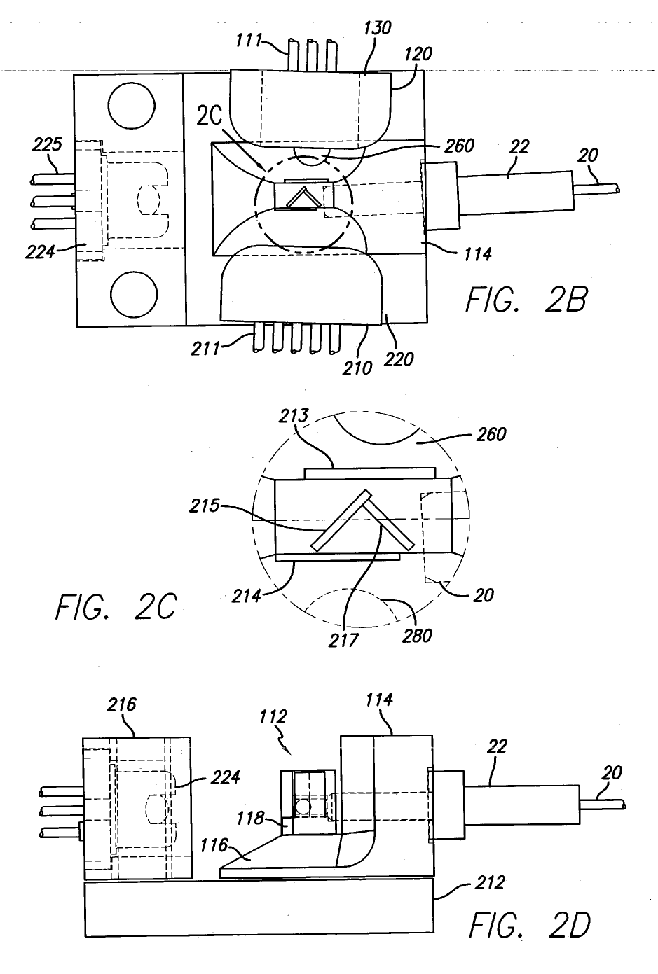

Referring to FIGS. 1A-1B and 2A-2D an optical module in accordance with a preferred embodiment of the present invention is illustrated in perspective and component views, respectively. The optical module illustrated is a configuration employing optical components and alignment suitable for an application in a fiber optic distribution network.

Referring first to FIGS. 1A and 1B, optical module 10 is illustrated in perspective views. The optical module 10 comprises plural active optical components as well as optional passive optical components, such as beam splitters, isolators, filters and lenses, in any of a variety of combinations. The active optical components may include transmit laser diodes, back facet monitoring photodiodes and receiver photodiodes. These optical components are configured to optically couple modulated light signals to and from optical fiber 20. Although a single fiber is illustrated more than one fiber may also be coupled to the module, depending on the application. The optical fiber may be configured in a boot 24 as illustrated. Also, the module may include an optical connector such that the external fiber can be plugged in and out. The optical module 10 may preferably comprise a housing 11 which contains the one or more active optical components. The active optical components are mounted within housing 11 and have electrical leads 12 coupled to external circuitry such as transmit and receive circuitry, by flexible circuit boards 14, 16 and 18. The flexible circuit boards include pads 28 for soldering connections to the external circuitry on a PCB. The flexible circuit boards may include discrete circuit components 26 for impedance matching and filtering. The details of the flexible circuit board construction and method of coupling to the optical components and PCB are provided in U.S. patent application Ser. No. ______, to Meir Bartur and Sean Zargari, filed Jan. 22, 2003, for Flex Board Connection To An Optical Module, the disclosure of which is incorporated herein by reference in its entirety.

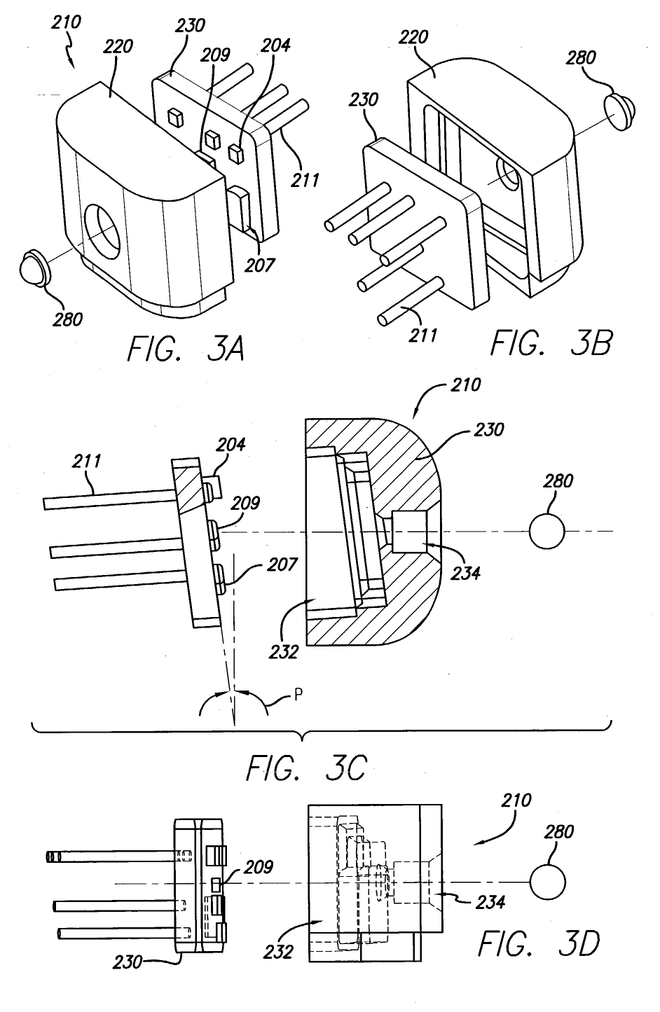

Referring to FIGS. 2A-2D the interior of the module 10 is illustrated showing an assembly 200 of optical components configured therein. The active optical components are shown relative to optical fiber 20 terminated in an optical fiber holder, sleeve, capillary tube, or ferrule 22 mounted in ferrule holder 114. Three active optical components modules 110, 201 and 210 are shown although this is by way of example only. The optical component modules 110 and 201 are illustrated as comprising active optical components 130 and 224 each configured in a cylindrical package, which may be a conventional cylindrical transistor outline (TO) package or “TO can”, mounted in respective component holders 120 and 216. The active optical component packages 130 and 224 may be press fit, secured by screws or otherwise securely mounted in respective component holders 120 and 216. The active optical components 130 and 224 may each comprise a laser diode, optical detector such as a diode photodetector, or other active optical component adapted for the particular application. The active optical component module 210 is described below in relation to FIGS. 3A-3D and comprises a hybrid optical and electrical module. That is, active optical component module comprises an active optical component such as a laser diode, photodetector or other known active optical component and also incorporates electrical circuitry in a common package; for example, built-in amplification circuitry in the case of a detector or modulation circuitry in the case of a laser diode or other light source. The active optical component modules 110 and 201 may also comprise such a hybrid module and all modules may be of such construction or various combinations with conventional packages may be employed. Therefore, the illustrated combination of one hybrid module and two conventional packages is provided by way of example only.

The optical component holders 114, 120 and 216, and module 210 are mounted in a fixed configuration, e.g. rigidly mounted on substrate 212, and are dimensioned so that the optical components are optically aligned, i.e., are dimensioned such that the nominal optical axis of each of the components is configured the same distance above the top surface of the substrate 212. The optical component holders 114, 120 and 216, and module 210 housing 220 may be composed of a suitable rigid material, such as a metal. For example brass is one example of a suitable metal, which might be employed. Preferably, both the holders 114, 120 and 216, and module 210 housing 220 are composed of materials of relatively low, and closely matched, coefficients of thermal expansion to that of substrate 212 so that temperature variations will not cause the relative alignment of the components to change. Holders 114, 120 and 216, and module 210 housing 220 may be rigidly affixed to substrate 212 via an epoxy or other bonding material. Other mounting means may be employed, however. Two mounting holes 226 and 228 are provided in holder 216 which receive mounting members such as a screw. This mounting system may allow attachment of a metal heat sink. Also, various other configurations and shapes of the optical component holder 120 and 216 and also optical component holder 114, geared to facilitate mounting to external package or a housing, special features that enable gripping and holding during manufacturing and other features are also possible. The active optical component electrical leads 111, 211 and 225 are shown extending from the respective modules. These are placed through the flexible circuit boards 14, 16 and 18 are soldered and extra lead length are cut to form the completed connections 12 shown in FIGS. 1A and 1B.

As best shown in FIGS. 2C and 2D, passive optical components are also preferably provided in assembly 200 in FIG. 2A to direct the light beam to the various active optical components. These passive optics may comprise a passive optics assembly 112 comprising optical filters 213 and 214 and beam splitters 215 and 217, provided in a holder 118 or mounted directly on extension 116 of fiber optic holder 114. If provided in a holder 118, such holder may be mounted to the fiber holder or directly on substrate 212. The choice of passive optical components and their configuration, both relative to each other and the fiber, may be selected for the specific implementation using criteria well known in the art. For example, the fiber is preferably angled slightly and the relative configuration is chosen generally to avoid undesired reflections as is well known in the art. Passive optical components may also include lenses 260 and 280. These may be incorporated in modules 110 and 210 or may be mounted on holder 118. Also, the active component modules 110 and 210 may be angled relative to fiber 20 as illustrated in FIGS. 2A and 2B to increase optically coupling and reduce reflections.

In one particular application module 10 and assembly 200 may comprise an optical triplexer that is capable of receiving both digital signals and broadband multi-channel RF modulated analog signals transmitted over a single fiber-optic cable for distribution systems of signals such as CATV\DBS, Cellular, PCS and others. Therefore, a specific combination of optical components in assembly 200 for such an application will be described. It should be appreciated, however, that the optical module of the present invention may be employed in other applications and with other optical components and configurations. Therefore, the present invention is not limited to optical triplexers or the specific illustrated combination of optical components and such merely provide one preferred embodiment of the present invention.

The triplexer comprises a photodiode receiver 130 for the digital receive signal, a hybrid receiver 210 for the analog receive signal, a laser diode 224 for digital transmit data, two dichroic beam splitters 215, 217, two optical filters 213 and 214 and a fiber optic cable 20 terminated with an optical ferrule 22. The assembly described above is contained in the outer shell 11 (shown in FIGS. 1A and 1B). The end users electrical interface to the hybrid receiver 210 is by soldering to the solder tabs 28 on the flex cable 14. The end user's electrical interface to the digital receiver 110 signal is by soldering to the solder tabs 28 on the flex cable 18. The end user's electrical interface to laser diode 224, digital transmit signal is by soldering to the solder tabs 28 on the flex cable 16.

All wavelengths of incoming light enter the fiber through the optical connector and exit the other end of the fiber directed towards the first beam splitter 217. Light with a wavelength of 1550 nm used by the particular analog system passes through beam splitter 217 and is reflected off the front surface of the second beam splitter 215, directed to the hybrid analog receiver and collected by the ball lens of the hybrid analog receiver 210. Incoming light with a wavelength of 1490 nm is reflected off the front surface of beam splitter 217, directed to the photodiode for the digital receive module 110. Light emitted by the laser diode 224 has a wavelength of 1310 nm and is transparent to both beam splitter 215 and 217, and therefore propagates through the assembly and enters the fiber 20 where it passes through to the connector end of the fiber with a minimal loss. Filter 213 is positioned between beam splitter 217 and the digital receiver 110 to provide additional optical isolations to other wavelengths. Filter 213 filters out all wavelengths outside the window of 1480 to 1500 nm. This prevents spurious light from the laser 224 (1310 nm) and the analog receive signal (1550 nm) from getting to the digital receiver 130. Filter 214 filters out all wavelengths outside 1540 to 1560 nm. This prevents spurious light from the laser 224 (1310 nm) and the digital receive signal (1490 nm) from getting to the photodiode of the hybrid analog receiver 210. Traps are also provided which provide for very low reflection of any stray beams.

Details on assembling the triplexer and additional optical component mounting configurations are disclosed in U.S. patent application Ser. No. 09/836,500 for OPTICAL NETWORKING UNIT EMPLOYING OPTIMIZED OPTICAL PACKAGING to Meir Bartur et al., filed Apr. 17, 2001, the disclosure of which is incorporated herein by reference in its entirety. In addition, published PCT application of the same title, international application number PCT/US01/27436, discloses similar subject matter and is incorporated herein by reference in its entirety.

Also, as discussed above the illustrated three active optical component embodiment is purely provided as an example and other combinations of optical components may be provided. Specific examples of other combinations of optical components are also described in the above noted U.S. patent application Ser. No. 09/836,500 and international application number PCT/US01/27436, incorporated herein by reference in their entirety, and the incorporation of the present in such alternate combinations is implied herein.

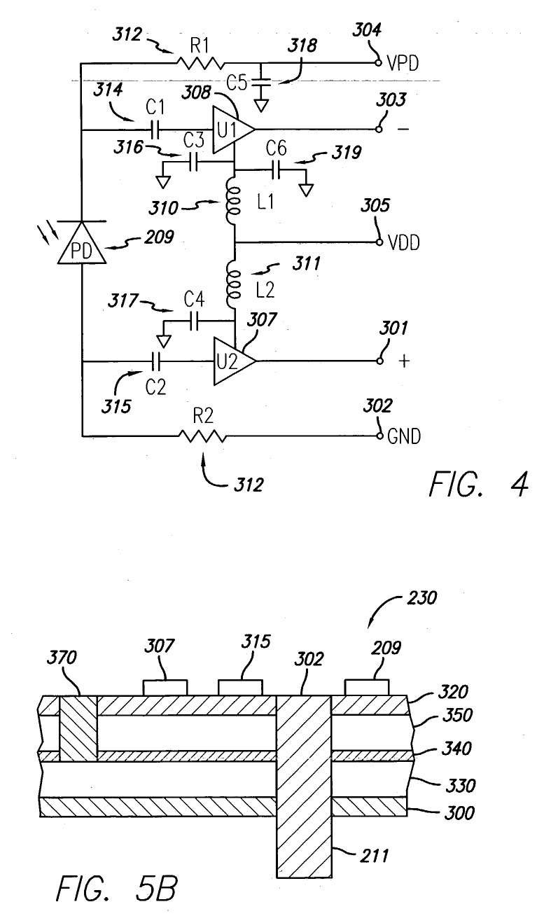

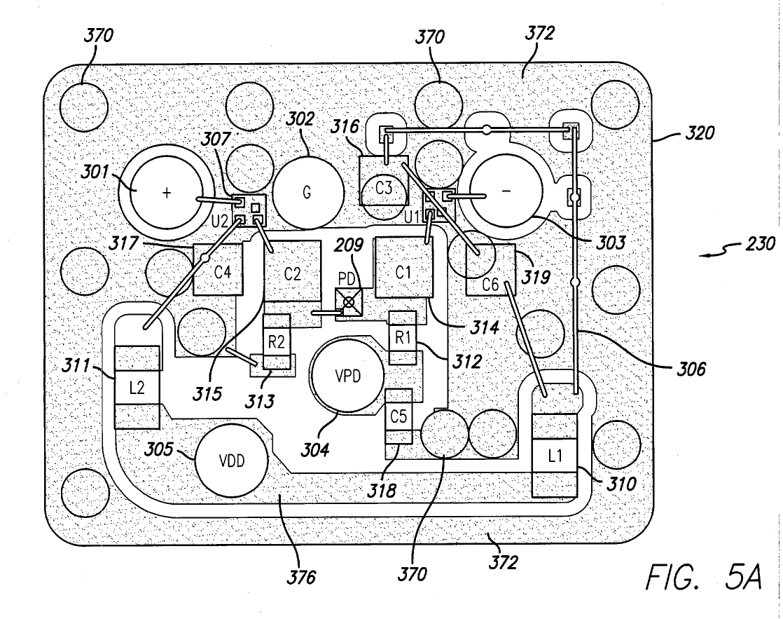

Referring to FIGS. 3A-3D a hybrid active optical component module in accordance with a preferred embodiment of the present invention is shown. The hybrid active optical component module may comprise one or more of optical component modules 110, 201 and 210, described in relation to FIGS. 2A-2D. For specificity and as an example only, the hybrid optical component module is shown and described as optical component module 210 comprising an active optical component which may comprise a photodiode receiver and associated electrical circuitry. The hybrid optical component module is a microelectronics assembly comprising a microelectronics substrate 230 (e.g. printed circuit board material shown in FIG. 3A), which has the active optical component photodiode 209, one or more integrated circuits 207, one or more discrete components 204 and interface connector pins 211 mounted on it. A specific circuit and physical layout of substrate 230 are described below in relation to FIGS. 4 and 5A and 5B. The substrate 230 is mounted into a metal housing 220 which preferable contains a glass ball lens 280 in recess 234. The substrate 230 may be secured in a recess 232 in housing 220 via epoxy or solder. A press fit or other/mounting approach may also be used. The location of the photodetector 209 on the substrate 230 is such that when the substrate assembly is mounted into the metal housing, the ball lens 280 in the metal housing is directly in alignment with the optical active area of the photodetector. The correct focal length of the ball lens to the photodetector is also set by the location of the substrate in the metal housing. The surface of the substrate, and therefore the surface of the photodetector, may be angled by an angle P as shown in FIG. 3C, e.g. 5-8 degrees, to the path of the incoming incident light. This angle offset is also accomplished by the mounting of the substrate to the housing as shown in FIGS. 2A-2B. The purpose of the angle is the reflected optical light from the surface of the photodiode will not reflect back into the fiber cable and hence prevent degrading the optical return loss of the module. The incoming incident light containing the optical signal is collected by the ball lens 280 in the metal housing, directed to and focused on the active area of the photodetector 209. The surface of the photodetector 209 is somewhat reflective. Some of the incoming light is therefore reflected off the surface of the photo detector. The substrate offset of 5-degrees to the incident light path prevents the reflected light from travelling on the same path as the incoming beam, thus unwanted optical reflections are prevented from returning light back to the source.

Referring to FIG. 4 an electrical schematic drawing of one specific circuit for the hybrid optical component module in accordance with a preferred embodiment of the present invention is illustrated. As discussed above, the hybrid optical component module includes an active optical component and electrical circuitry adapted for the specific application and optical element. In FIG. 4 the specific circuitry corresponds to an integrated optical receiver that is capable of receiving broadband multi-channel RF modulated signals transmitted over the fiber-optic distribution system such as CATV and DBS cellular or other high frequency signals. The optical element comprises a photodiode (PD) 209. The photodiode 209 converts the received optical power to electrical signal current. Following the photodiode are two high gain, low impedance amplifiers 307 and 308 preferably provided as integrated circuits U1 and U2. The amplifiers provide low impedance voltage output signals, which are phase shifted by 180 degrees. This configuration is called Push-Pull because the signals generated at the photodiode 209 are 180 degrees out of phase; that means one of the low noise amplifiers is sinking the current from the PD 209 and the other low noise amplifier sourcing the current. The Push-Pull design is capable of significantly reducing the even order intermodulation distortion of each of the low noise amplifiers, which is otherwise not possible using only one low noise amplifier. Additional details of a Push-Pull design are provided in U.S. Provisional Patent Application serial No. 60/353,118, filed on Feb. 1, 2002, which is incorporated herein by reference. The two outputs from amplifiers 307 and 308 are provided at output pins 301 and 303, respectively. The circuit illustrated also receives power VPD for the photodiode from pin 304 and power VDD for the amplifiers from pin 305. A ground connection is also provided from pin 302.

As may be appreciated from the layout of FIG. 4 the electrical circuitry has a generally symmetrical or balanced configuration about the active optical element 209. This enhances the effectiveness of the Push-Pull design. Also the circuitry includes additional elements to balance the circuit and control the impedance of the circuit paths. More specifically, the circuit includes AC coupling capacitors 315 and 314 having capacitances C1 and C2 chosen to couple and filter the input signals to amplifiers 307 and 308. The circuitry also includes power supply filtering capacitors 316, 317, 318 and 319 coupled to ground and having capacitances C3, C4, C5 and C6 chosen to reduce the noise from the power supplies to the photodiode 209 and amplifiers 307, 308. The circuitry also includes resistors 312 and 313 having resistances R1 and R2, chosen for biasing the photodiode 209. The circuitry also includes RF chokes implemented as inductors 310 and 311 having inductances L1 and L2 chosen to isolate the power supply pin 305.

Referring to FIGS. 5A and 5B the physical layout of the circuit board 230 is shown, in accordance with a preferred embodiment of the present invention. More specifically, FIG. 5A is a top view of the circuit board layout and FIG. 5B is a side view of the circuit board 230. The circuit board 230 preferably has a multi-layer structure comprising a bottom support layer 300, insulating layers 330 and 350, a ground plane layer 340 and an upper circuit component layer 320. The upper circuit component layer 320 is shown in FIG. 5A. As may be appreciated from FIG. 5A the layout of the circuitry provides a balanced or symmetrical configuration about photodiode 209 to exploit the push-pull design of the circuit as discussed above. The specific circuit elements shown in FIG. 5A have been described above in relation to FIG. 4. The specific circuit elements may be provided as discrete components mounted on circuit board substrate 320 in a known manner. The discrete components are electrically coupled by conductive metal patterns or traces 376 on the substrate as well as by selective wire bonds 306, indicated as heavy lines in FIG. 5A. The wire bonds 306 are provided between selected electrical components to provide for connectivity between components where traces in the substrate are not possible or practical, careful selection of proper wire-bond thickness and assembly is important to improve impedance matching and to minimize power loss in the circuit due to impedance mismatch. The circuit components are also surrounded by a conductive metal layer 372 which is coupled to a ground plane layer (shown in FIG. 5B) by conductive plated through holes 370 in the substrate. When combined with the metal housing 220 surrounding the circuit board 230 this provides RF shielding of the circuitry. The pins 301, 302, 303, 304 and 305 extend through the circuit board and correspond to pins 211 described above.

It should be appreciated that the foregoing description of the preferred embodiments of the present invention may be modified in a variety of different ways which should be apparent to those skilled in the art from the above teachings. Accordingly, the present invention should not be limited in any way to the illustrated embodiments as the present invention in its various aspects encompasses all such modifications and variations thereof which are too numerous to describe in specific detail herein. While the invention has been illustrated and described by means of specific embodiments, it is to be understood that numerous changes and modifications may be made therein without departing from the intent and scope of the invention as defined in the appended claims.

What is claimed is:

1. A hybrid optical and electrical module, comprising:
an optical fiber;
a first active optical component module configured in a fixed relation to said fiber, said first active optical component module comprising a substrate, a first active optical component mounted on said substrate to optically couple to said fiber, and an electrical circuit on said substrate electrically coupled to said first active optical component comprising at least one integrated circuit and having first external electrical leads to connect with external circuitry; and
a second active optical component configured in a fixed relation to said first active optical component module and to said fiber to optically couple to said fiber and having second external electrical leads to connect with external circuitry.

2. A hybrid optical and electrical module as set out in claim 1, wherein said first active optical component comprises a photodiode.

3. A hybrid optical and electrical module as set out in claim 1, wherein said at least one integrated circuit comprises an amplifier.

4. A hybrid optical and electrical module as set out in claim 1, further comprising a third active optical component configured in a fixed relation to said fiber to optically couple to said fiber.

5. A hybrid optical and electrical module as set out in claim 1, wherein said first active optical component module further comprises a lens mounted in the optical path of said first active optical component.

6. A hybrid optical and electrical module as set out in claim 1, wherein said first active optical component module further comprises a metal housing and wherein said substrate is mounted in said metal housing.

7. A hybrid optical and electrical module as set out in claim 6, wherein said second active optical component is mounted in a second housing.

8. A hybrid optical and electrical module as set out in claim 7, wherein said first active optical component module, said optical fiber and said second housing are mounted in a third housing and wherein said third housing has openings to provide electrical contact to said first and second external electrical leads.

9. A hybrid optical and electrical module as set out in claim 7, further comprising a rigid base and wherein said first active optical component module and said second housing are mounted on said base.

10. A hybrid optical and electrical module as set out in claim 9, further comprising an optical fiber holder mounted to said rigid base and wherein said optical fiber is mounted in said optical fiber holder.

11. A hybrid optical and electrical module as set out in claim 1, further comprising first and second flexible circuit boards coupled to said first and second external electrical leads.

12. A hybrid optical and electrical module as set out in claim 8, further comprising first and second flexible circuit boards coupled to said first and second external electrical leads.

13. A hybrid optical and electrical module as set out in claim 1, further comprising a beam splitter configured in the optical path between said optical fiber, first active optical component and second active optical component.

14. A hybrid optical and electrical triplexer module comprising:
a single optical fiber;
a laser diode configured in a fixed relation to said fiber having first external electrical leads to connect with external circuitry;
a first photodiode module configured in a fixed relation to said laser diode and said fiber, said first photodiode module comprising a substrate, a first photodiode mounted on said substrate in a position to optically couple to said fiber to receive light from said fiber, and an electrical circuit on said substrate electrically coupled to said first photodiode comprising at least one integrated circuit and at least one discrete circuit component, said first photodiode module having second external electrical leads to connect with external circuitry; and
a second photodiode module configured in a fixed relation to said laser diode, first photodiode module and to said fiber, said second photodiode module comprising a second photodiode configured in a position to optically couple to said fiber to receive light from said fiber, said second photodiode module having third external electrical leads to connect with external circuitry.

15. A hybrid optical and electrical triplexer module as set out in claim 14, further comprising a first beam splitter and a second beam splitter configured to direct light from said fiber to said first and second photodiodes, respectively.

16. A hybrid optical and electrical triplexer module as set out in claim 14, wherein said at least one integrated circuit comprises an amplifier.

17. A hybrid optical and electrical triplexer module as set out in claim 14, wherein said at least one discrete circuit component comprises a capacitor.

18. A hybrid optical and electrical triplexer module as set out in claim 14, wherein said at least one discrete circuit component comprises a resistor.

19. A hybrid optical and electrical triplexer module as set out in claim 14, wherein said first photodiode module comprises a housing and wherein said substrate is mounted in said housing.

20. An optical receiver module comprising a substrate, a photodiode mounted on said substrate in a position to optically couple to said fiber to receive light from said fiber, an electrical circuit on said substrate electrically coupled to said first photodiode comprising a first amplifier configured as an integrated circuit, a second amplifier configured as an integrated circuit and at least one discrete circuit component, and external electrical leads extending through said substrate to connect with external circuitry on the other side of said substrate.

21. An optical receiver module as set out in claim 20, wherein said first and second amplifier are configured symmetrically about said photodiode on said substrate.

22. An optical receiver module as set out in claim 20, wherein said at least one discrete circuit component comprises a plurality of circuit components configured substantially symmetrically about said photodiode.

23. An optical receiver module as set out in claim 22, wherein said plurality of circuit components are substantially impedance matched.

24. An optical receiver module as set out in claim 20, wherein said substrate further comprises a ground plane layer and a metal via connecting the ground plane layer to the electrical circuit layer.
